(19) United States
(12) Patent Application Publication
(10) Pub. No.: US 2007/0296321 A1
(43) Pub. Date: Dec. 27, 2007

(54) CARBON NANOTUBE FIELD EMISSION DEVICE AND METHOD FOR MANUFACTURING THE SAME

(75) Inventors: ZHI ZHENG, Beijing (CN); PENG LIU, Beijing (CN); SHOU-SHAN FAN, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Taipei Hsien (TW)

(21) Appl. No.: 11/556,641

(22) Filed: Nov. 3, 2006

(30) Foreign Application Priority Data
Jun. 23, 2006 (CN) 200610061307.8

(51) Int. Cl. H01J 1/02

(52) U.S. Cl. 313/309

(57) ABSTRACT

An exemplary carbon nanotube field emission device includes a cathode, at least one carbon nanotube emitter formed on the cathode, an anode facing the cathode, at least one gate electrode arranged between the cathode and the anode, at least one spacer arranged between the gate electrode and the cathode, and an electrically insulating layer formed on an underside surface of the gate electrode. The at least one spacer defines at least one cavity therein with the at least one carbon nanotube emitter being received in the at least one cavity. The electrically insulating layer is configured for preventing the underside surface of the gate electrode from being exposed to the cavity. A method for manufacturing a carbon nanotube field emission device is included.

### BACKGROUND

1. Technical Field

The present invention generally relates to field emission devices and methods for manufacturing the same, and more particularly to a carbon nanotube field emission device that can prevent short circuiting between cathode and gate electrode and a method for manufacturing the same.

2. Description of Related Art

Carbon nanotubes are a relatively new material having a hollow tubular structure composed of a number of carbon atoms. Carbon nanotubes were first discovered by Iijima in 1991, and reported in an article entitled “Helical Microtubules of Graphitic Carbon” (Nature, No. 354, pages 56-58, 1991).

Flat display devices have several types, such as, liquid crystal display devices, plasma display devices, carbon nanotube field emission devices, etc. Compared with cathode ray tubes display devices, the flat display devices in general have the characteristics of thinness, good display, large view angle, low power, lightness (in weight), etc. Carbon nanotube field emission devices use carbon nanotubes as electron emitters. With the ongoing developments of methods for manufacturing the carbon nanotubes, researches of the carbon nanotube field emission devices have now achieved important progress.

The carbon nanotube field emission devices include diode structures and triode structures. Diode carbon nanotube field emission devices have conventional structure and can be easily manufactured. However, controlling emission current is difficult and moving pictures and gray-scale pictures formed using them are poor. Accordingly, instead of diode structures, triode structures are commonly required.

A typical triode carbon nanotube field emission device includes a cathode, an anode, and at least one gate electrode. A vacuum chamber between the cathode and the anode is maintained by several spacers. The gate electrode is sandwiched between the anode and the spacers. The cathode has a number of carbon nanotubes as emitters formed thereon. When the spacers are formed by a wet etching method, the spacers are more easily etched than the gate electrode due to the differing substances used in their construction. Nevertheless, during the electron emitting process, when the height of the carbon nanotubes is equal to or over the height of the spacers, the carbon nanotubes touch the gate electrode. As a result, short-circuiting between the cathode and the gate electrode occurs. Electrons emitted by the carbon nanotubes near the gate electrode can directly shoot onto the gate electrode, thus a drain current is generated and an emittion efficiency of the whole device is reduced.

What is needed, therefore, is a carbon nanotube field emission device that can prevent short circuiting and drain current, and a method for manufacturing the same.

### SUMMARY

In an embodiment, a carbon nanotube field emission device includes a cathode, at least one carbon nanotube emitter formed on the cathode, an anode facing the cathode, at least one gate electrode arranged between the cathode and the anode, at least one spacer arranged between the gate electrode and the cathode, and an electrically insulating layer formed on an underside surface of the gate electrode. The at least one spacer defines at least one cavity therein with the at least one carbon nanotube emitter received in the at least one cavity. The electrically insulating layer is configured for preventing the underside surface of the gate electrode from being exposed to the cavity.

In another embodiment, a method for manufacturing a carbon nanotube field emission device includes steps of: providing a substrate; forming a cathode on the substrate; forming a first electrically insulating layer on the cathode; forming a second electrically insulating layer on the first electrically insulating layer; forming a gate electrode layer on the second electrically insulating layer; etching the second electrically insulating layer to define at least one opening in the second electrically insulating layer; wet etching the first electrically insulating layer through the at least one opening in the second electrically insulating layer to define at least one cavity in the first electrically insulating layer using an etchant, wherein the first electrically insulating layer is more easily etched than the second electrically insulating layer; growing carbon nanotubes on the cathode in the at least one cavity; and arranging an anode to face the cathode to form a carbon nanotube field emission device.

Other advantages and novel features will become more apparent from the following detailed description of the present carbon nanotube field emission device and method for manufacturing same when taken in conjunction with the accompanying drawings.

### BRIEF DESCRIPTION OF THE DRAWINGS

Many aspects of the present carbon nanotube field emission device and method for manufacturing the same can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic view of a carbon nanotube field emission device, in accordance with an embodiment of the present invention.

FIG. 2 is a schematic view of a substrate, in accordance with another embodiment of the present invention,

FIG. 3 is similar to FIG. 2, but showing an insulating layer formed on the substrate shown in FIG. 2.

FIG. 4 is similar to FIG. 3, but showing a cathode formed on the insulating layer shown in FIG. 3.

FIG. 5 is similar to FIG. 4, but showing a first electrically insulating layer formed on the cathode shown in FIG. 4.

FIG. 6 is similar to FIG. 5, but showing a second electrically insulating layer formed on the first electrically insulating layer shown in FIG. 5.

FIG. 7 is similar to FIG. 6, but showing a gate electrode layer utilized to form at least one gate electrode formed on the second electrically insulating layer shown in FIG. 6.

FIG. 8 is similar to FIG. 7, but showing at least one cavity, spacer, opening, insulating layer, hole, and gate electrode formed by etching the first electrically insulating layer, the second electrically insulating layer, and the gate electrode layer shown in FIG. 7.

FIG. 9 is similar to FIG. 8, but showing a catalyst layer formed in the at least one cavity shown in FIG. 8.

FIG. 10 is similar to FIG. 9, but showing a number of carbon nanotubes grown from the catalyst layer in the cavity shown in FIG. 9.

FIG. 11 is similar to FIG. 10, but showing a anode facing the gate electrode shown in FIG. 10.

### DETAILED DESCRIPTION OF PREFERRED EMBODIMENT

Reference will now be made to the drawing figures to describe the preferred embodiments of the present carbon nanotube field emission device and method for manufacturing the same in detail.

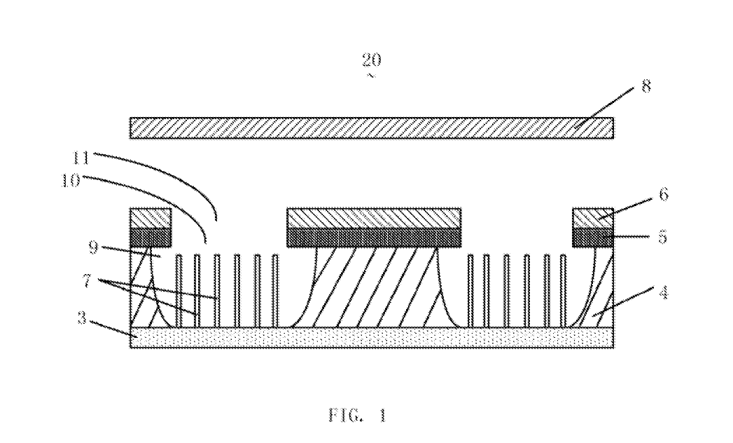

Referring to FIG. 1, a carbon nanotube field emission device 20 in accordance with an embodiment is shown. The device 20 includes a cathode 3, at least one spacer 4, an electrically insulating layer 5, at least one gate electrode 6, and an anode 8 arranged in that order.

The at least one spacer 4 is arranged between the cathode 3 and the gate electrode 6 and is configured for separating the cathode 3 and the gate electrode 6. A material of the spacer 4 is selected from the group consisting of SiO₂, MgO, Al₂O₃, ZnO, and a mixture thereof. The at least one spacer 4 defines at least one cavity 9 and the cavity 9 is configured for exposing the cathode 3.

A number of carbon nanotubes 7 as an electron emitter are formed in the at least one cavity 9 and electrically connected with the cathode 3.

The electrically insulating layer 5 is formed on the spacer 4 and defines at least one opening 10. A material of the electrically insulating layer 5 is Si₃N₄. A thickness of the electrically insulating layer 5 is in the approximate range from 0.1 microns to 1 micron.

The anode 8 faces the electrically insulating layer 5. The least one gate electrode 6 is arranged on the electrically insulating layer 5. That is it that the electrically insulating layer 5 is between the gate electrode 6 and the spacer 4, and the electrically insulating layer 5 covers an underside surface of the gate electrode 6 facing the spacer 4. The gate electrode 6 defines at least one gate electrode hole 11 corresponding to the opening 10. Electrons emitted by the carbon nanotubes 7 shoot onto the anode 8 through the opening 10 and the hole 11.

The electrically insulating layer 5 arranged between the spacer 4 and the gate electrode 6 can prevent the carbon nanotubes 7 touching the gate electrode 6. As a result, short-circuiting between the carbon nanotubes 7 and the gate electrode 6 is significantly reduced and a drain current is reduced.

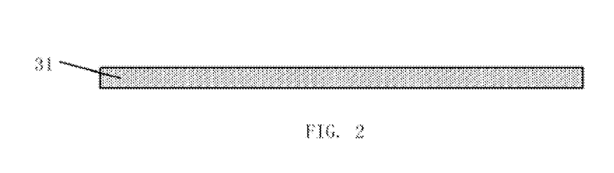

Referring to FIGS. 2 to 11, a method for manufacturing a carbon nanotube field emission device is described in detail.

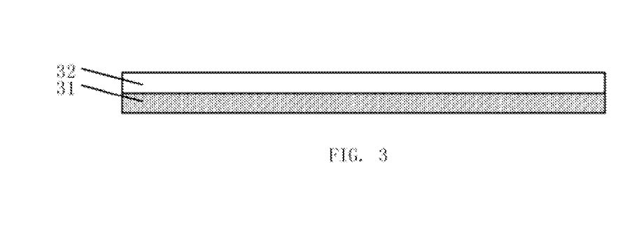

Referring to FIGS. 2 to 3, a substrate 31 is provided and an insulating layer 32 is formed on a surface of the substrate 31. Alternatively, the insulating layer 32 can also omit.

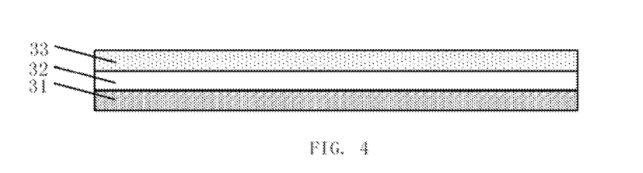

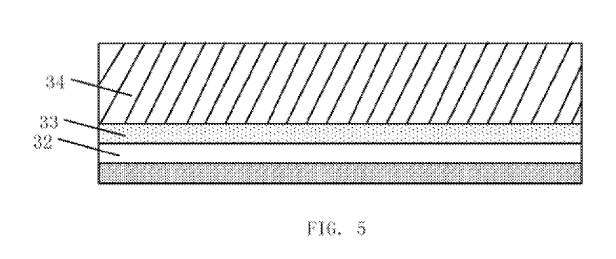

Referring to FIGS. 4 to 5, a cathode 33 is formed on the insulating layer 32 and a first electrically insulating layer 34 is formed on the cathode 33. A material of the first electrically insulating layer 34 is SiO₂. The first electrically insulating layer 34 is achieved by a chemical vapor deposition method or a plasma enhanced chemical vapor deposition method.

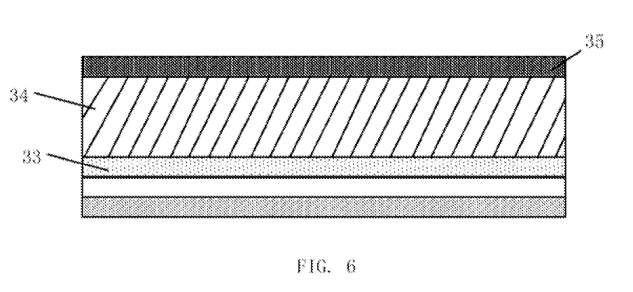

Referring to FIG. 6, a second electrically insulating layer 35 is formed on the first electrically insulating layer 34. A material of the second electrically insulating layer 35 is Si₃N₄. The second electrically insulating layer 35 is achieved by a chemical vapor deposition method or a plasma enhanced chemical vapor deposition method.

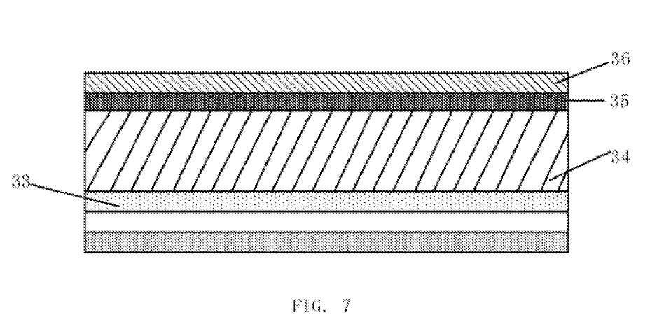

Referring to FIG. 7, a gate electrode layer 36 is formed on the second electrically insulating layer 35. The gate electrode layer 36 is used to form at least one gate electrode.

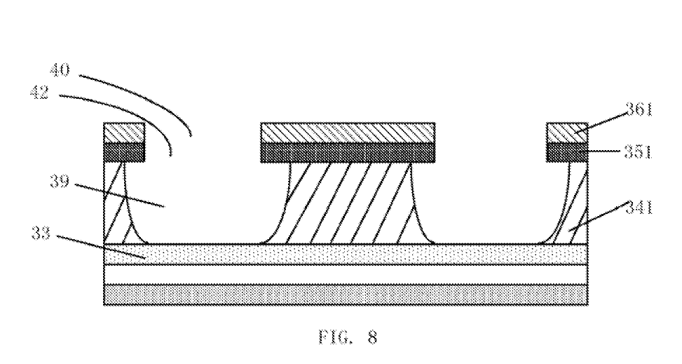

Referring to FIG. 8, the gate electrode layer 36, the second electrically insulating layer 35, and the first electrically insulating layer 34 are etched.

At least one gate electrode hole 40 and at least one gate electrode 361 are defined in the gate electrode layer 36. At least one opening 42 and electrically insulating layer 351 are defined in the second electrically insulating layer 35. At least one cavity 39 and at least one spacer 341 are defined in the first electrically insulating layer 34. The second electrically insulating layer 35 is etched through the hole 40 in the gate electrode layer 36 and the first electrically insulating layer 34 is etched through the opening 42 in the second electrically insulating layer 35. Thus, the cathode 33 is exposed. A wet etching method is performed on the first electrically insulating layer 34 and a dry etching method is performed on the gate electrode layer 36 and the second electrically insulating layer 35. The wet etching method uses a solution containing hydrofluoric acid and ammonium fluoride as an etchant. The material of the second electrically insulating layer 35 is different with the material of the first electrically insulating layer 34, therefore, the first electrically insulating layer 34 is thus more etched than the second electrically insulating layer 35. Therefore, the electrically insulating layer 351 can prevent the undersurface of the gate electrode 361 being exposed to the cavity 39.

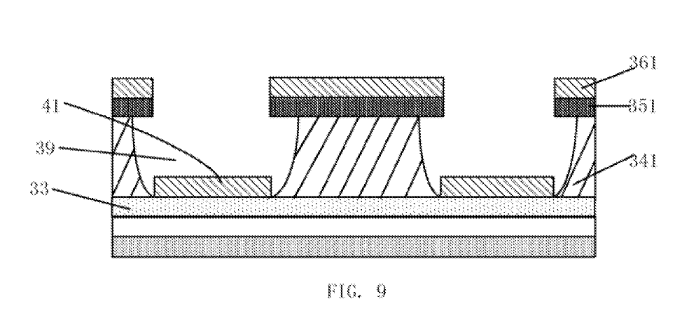

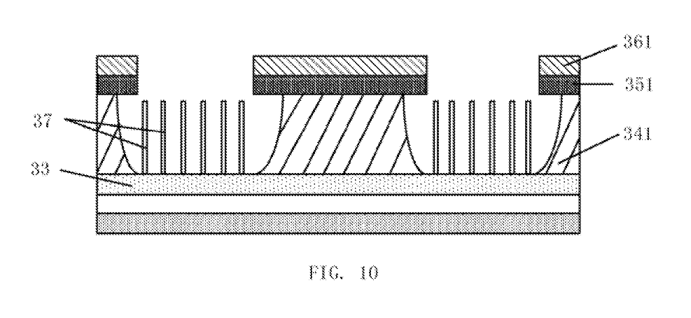

Referring to FIGS. 9 and 10, a catalyst layer 41 is formed in the at least one cavity 39 and carbon nanotubes 37 as electron emitter are grown using, for example, a chemical vapor deposition method.

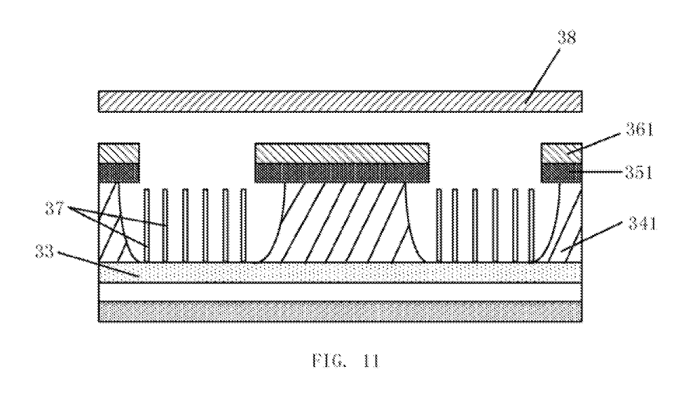

Referring to FIG. 11, a anode 38 is arranged facing the gate electrode 361 to form a carbon nanotube field emission device.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A carbon nanotube field emission device, comprising:
a cathode;
at least one carbon nanotube emitter formed on the cathode;
an anode facing the cathode;
at least one gate electrode arranged between the cathode and the anode;
at least one spacer arranged between the gate electrode and the cathode, the at least one spacer defining at least one cavity therein with the at least one carbon nanotube emitter being received in the at least one cavity; and
an electrically insulating layer formed on an underside surface of the gate electrode, the electrically insulating layer being configured for preventing the underside surface from being exposed to the cavity.

2. The device as claimed in claim 1, wherein a material of the insulating layer is Si₃N₄.

3. The device as claimed in claim 1, wherein the insulating layer has a thickness in the range from 0.1 microns to 1 micron.

4. A method for manufacturing a carbon nanotube field emission device, comprising the steps of:
providing a substrate;
forming a cathode on the substrate;
forming a first electrically insulating layer on the cathode;
forming a second electrically insulating layer on the first electrically insulating layer;
forming a gate electrode layer on the second electrically insulating layer;
etching the second electrically insulating layer to define at least one opening in the second electrically insulating layer;
wet etching the first electrically insulating layer through the at least one opening in the second electrically insulating layer to define at least one cavity in the first electrically insulating layer using an etchant, wherein the first electrically insulating layer is more easily etched than the second electrically insulating layer;
growing carbon nanotubes on the cathode in the at least one cavity; and
arranging an anode to face towards the cathode to form a carbon nanotube field emission device.

5. The method as claimed in claim 4, wherein portions of an underside of the gate electrode facing the at least one cavity are covered by the second electrically insulating layer.

6. The method as claimed in claim 4, wherein the at least one opening is defined by dry etching the second electrically insulating layer.

7. The method as claimed in claim 4, wherein a material of the first electrically insulating layer is SiO₂.

8. The method as claimed in claim 4, wherein a material of the second electrically insulating layer is Si₃N₄.

9. The method as claimed in claim 4, wherein the etchant is a solution containing hydrofluoric acid and ammonium fluoride.
